(19) United States
(12) Patent Application Publication
(10) Pub. No.: US 2022/0221614 A1
(43) Pub. Date: Jul. 14, 2022

(54) Analysis method, system and storage media of lithological and oil and gas containing properties of reservoirs

(71) Applicant: Shandong University of Science and Technology, Shandong (CN)

(72) Inventors: Jifeng Yu, Shandong (CN); Tianjiao Liu, Shandong (CN); Haibo Jia, Shandong (CN); Huitao Cao, Shandong (CN); Yadong Wang, Shandong (CN); Diandong Zhang, Shandong (CN); Xiaoke Hu, Shandong (CN); Haimeng Yang, Shandong (CN); Zihao Jiang, Shandong (CN); Shuhao Wei, Shandong (CN)

(21) Appl. No.: 17/210,840

(22) Filed: Mar. 24, 2021

(30) Foreign Application Priority Data
Jan. 11, 2021 (CN) 2021100339881

(51) Int. Cl. G01V 11/00; E21B 49/00; G01V 1/40; G01V 5/12

(52) U.S. Cl. CPC G01V 11/002; G01V 5/12; G01V 1/40; E21B 49/00

(57) ABSTRACT

The present invention discloses an analysis method, system and storage medium of lithology and oil and gas containing properties of reservoirs, by getting spectral structure modes of logging signals of different lithological bands and different oil and gas containing strata with CWTFT algorithms from frequency spectral structural relationships between different chords in music by analogy; summarizing features of spectral structure modes of same lithology in different wells, and getting a spectral change law of rocks, and identifying lithology of unknown rocks; and analyzing characteristics of reservoirs from identified lithology, finding and comparing spectral change characteristics of oil and gas strata in different wells to predict oil and gas reservoirs. The present invention combines spectral response characteristics of logging curves of different lithology, improves accuracy and efficiency of lithology and reservoir features interpretation work and provides new theoretical support and practical experience for deep oil and gas reservoir prospection and development.

### TECHNICAL FIELD

The present invention belongs to lithological identification and analysis and physical parameters of reservoirs prediction, especially an analysis method, system and storage media of lithological and oil and gas containing properties of reservoirs.

### BACKGROUND TECHNOLOGY

Currently, geophysical logging is a branch of geophysics, abbreviated as “logging”. By logging, a variety of instruments are used to measure various physical parameters in underground strata to address oil and gas during underground mines such as petroleum, natural gas and coal mines prospection and exploitation. Geophysical logging can be divided into four stages chronologically. Early stage (1929-1949): Schlumberger brothers and Henri George Doll ran the first logging in the world. In 1934, the first well log interpretation paper appeared. On Dec. 20, 1939, the first logging in China was done in Well Bal in the Shiyougou Structure of Baxian County in Sichuan Province by Academician Wong, Wenbo. In 1942, Archie proposed the relationship between porosity and resistivity logging data and water saturation parameters of rocks, which makes it possible to establish quantitative relationship instead of only characterization, and represents a revolution of logging interpretation. Intermediate stage (1929-1968): induction log/sonic log/laterolog/compensated neutron log/compensated density log are introduced in succession. In 1956, M. J. Wyllie proposed to use average equation in porosity calculation in acoustic well log. Early modern stage (1969-1979): in the 1970s, computer technology has been applied to logging work, computerized logging technology has been developed with logging data and processing computerized, and on-vehicle computers provided quick and visual interpretation to users in well fields timely. Modern stage (1979˜): logging techniques and methods become more and more advanced with new instruments used and appearance of borehole imaging, and computer technology, such as computer wavelet analysis and frequency analysis, is widely used in data acquisition and processing, which improves logging data processing capacity.

At present, logging technology has been developing quickly, tens of logging techniques are available now, such as Sonic log (AC), Gamma Ray log (GR), and Spontaneous Potential log (SP) among conventional well logs, and Nuclear Magnetism log (NML), Acoustic Full Wave log (XMAC), Ultrasonic Image log (UHL), and FOCUS combination log among new well logs. Many geological problems have been solved, such as lithological explanation, stratum comparison and reservoir characterization. When it is to analyze response features in the logging data, various kinds of methods, such as well log curve shape, fast Fourier transform (FFT), continuous wavelet transform (CWT), are used to extract the same, however, due to complexity of strata structure, especially lithological and reservoir characteristic analysis based on well log curve shapes serves only to characterize lithology and reservoirs, and is subject to influences from underground elements, analysis inaccuracy is liable to happen. Wherein, FFT is a fast algorithm of discrete Fourier transformation, to transform a signal into a frequency domain. It may be not possible to see features of some signals in a time domain but it is possible to find the same in a frequency domain. And that is why FFT transformation is used in signal analysis. In addition, it is possible to extract frequency spectrum of a signal with FFT, which is usually used in frequency spectral analysis. Wavelet transform can be say an upgrade version of Fourier transform and has effectively addressed the time-frequency localization problem, and dividing a well log curve into a frequency domain and a time domain. Wavelet transform provides low time resolution and high frequency resolution at low frequencies and high time resolution and low frequency resolution at high frequencies, which is suitable for using in non-smooth signal analysis and local feature of signals extraction, and Wavelet transform is accredited as a microscope in signal analysis and processing. Frequency spectral feature analysis is widely used, such as in music of early frequency spectrum, in radio and signal analysis field of frequency spectrum, and frequency spectrum is gradually applied in geological field, primarily in sedimentary cycle of strata and sequence stratigraphy, where universality and importance of frequency spectral analysis can be seen. Literature that uses Wavelet transform in geological data study in China and abroad focuses mainly on seismic data processing and seismic stratigraphy field.

Spectrum is first used in optical field; a beam of light will be decomposed into red, orange, yellow, green, indigo, blue and violet colors, which are called “spectrums”, according to wavelengths of the light, when passing a triple prism. To describe how frequent something appears periodically, frequency in a time series can be used. Frequency spectral analysis is a common statistical and analytical method used in studying periodical phenomena, and Fourier transform or Wavelet transform is used to project a given signal from a time feature (domain) to a frequency feature (domain) to extract necessary frequency (or periodical signals) from the time series and have the same more clearly represented. By frequency spectral analysis, the time series can be processed quickly, to analyze how many regular elements there are and show wavelengths of all regular elements in the time series. Frequency spectral analysis has been used in geological field for long, and a lot of accomplishments have been made, chiefly in stratum recognition, but application in lithological identification and reservoir feature study is few.

From the foregoing analysis, problems and deficiencies with the prior art can be seen as: frequency spectral analysis technology is seldom applied in lithological identification and reservoir feature researches; currently, frequency spectral analysis technology is mainly used in seismic signals, and rarely used in logging data, most of which are one-dimension signals, which shall be taken in conjunction with seismic data to get comprehensive characteristics regarding nature of geologic bodies. Time frequency calculation methods that are currently available are of insufficient accuracy and low resolution, and with rare drilling data, thin reservoirs and fast changing conditions, it is not possible to get highly accurate time frequency analysis outcomes; furthermore, lithological and reservoir features can be interpreted in more than one way, many factors may result in changes in drilling data, and corresponding change in frequency spectral features. Recently, with improvement of exploitation accuracy and emergence of new methods and new theories in the signal processing field, researches as to how to extract more new well log characteristics of definite physical and correspondingly geological significance to guide prospection and development, find meaningful oil and gas reservoir bands and identify oil and gas are still open.

Difficulties in addressing the abovementioned problems and deficiencies lie in: frequency spectral characteristics corresponding to different lithological characters remain unclear, it is necessary to choose logging data sensitive to lithological and reservoir characters for processing and interpretation, and get higher resolution and satisfy time-frequency analysis of higher accuracy by improving and combining multiple time frequency analysis method. Key of logging data frequency spectral analysis is to choose an appropriate time-frequency analysis method to improve utilization efficiency of logging data and retrieve more efficient geological information and for this purpose it is necessary to test different time-frequency analysis methods, and summarize applicable conditions and effects of different methods. Existing frequency spectral analysis algorithms primarily include: Fourier transform, continuous Wavelet transform, S-transform, and Wigner-Ville distribution. All these methods have their features and advantages, but there are deficiencies and limitations with them too, thus it is necessary to compare and analyze effects of these methods in lithological and reservoir feature extraction. Differences appear in analysis outcomes when processing the same logging data with different frequency spectral analysis methods. Wavelet analysis is a method with time-varying windows, which can be used to describe local characteristics of signals in both time-frequency domains, with high frequency resolution at low frequencies and high time resolution at high frequencies, and basis function in Fourier transform being amended, to achieve a localization property and to be used to conduct localized analysis to signals. Compared with other methods, Wavelet theory has made obvious improvements in time localization accuracy and frequency resolution, however, Wavelet analysis in its nature is still Fourier transform based on smooth signals and with adjustable windows, and efficiency of Wavelet transform depends directly on selection of a wavelet-function, sometimes it occurs that when frequency spectrum of an orthogonal basis function increases with shift of the scale, localization property deteriorates and consequently, finer decomposition of signals are restricted. Combination of Wavelet transform and Fourier transform provides a new way for frequency spectral analysis of logging data, and to innovate in researches of frequency spectral analyzing methods, study properties of time-frequency analyzing methods based on logging data, improve and enrich corresponding algorithms suitable for time-frequency analyzing methods of logging data, make use of latest products of modern signal processing, and come up with a time-frequency analyzing method with higher time-frequency resolution, computation efficiency, and applicable to processing of a variety of data, will build a foundation for time-frequency spectral decomposition of logging data, provide good theoretical support for engineering application, and is of great realistic meaning to oil and gas reservoir development area prospection in China.

Significances of addressing the abovementioned problems and deficiencies are that: the present invention has shown the script of an analytical program based on Fourier transform based Continuous Wavelet Transform (CWTFT) method, presented frequency spectral characteristics of computer generated signals and audio signals from musical instruments (piano and guitar), described with details aberrant signals appeared in the spectrogram and rendered reasonable interpretation for the same, so that when similar situation occurs in frequency spectral analysis of actual logging data, reason interpretation can be given, in the meantime, the present method can be improved and used in geology, such as identification of Milankovitch cycles and has unique advantages. Therefore, processing multi-dimension and non-linear logging data by frequency spectral analysis in combination with computer programming technology is conducive to improve efficiency and accuracy of geological interpretation work. Meanwhile, it is of far-reaching significance for automation and intelligent development of oil and geological industry.

### SUMMARY OF THE INVENTION

To address problems existing in the prior art, the present invention provides an analysis method, a system, and a storage medium of lithological and oil and gas containing properties of reservoirs.

The present invention is realized in the following manner, an analysis method of lithological and oil and gas containing properties of reservoirs, comprising: Getting frequency spectral structure modes of logging signals of different lithological bands and different oil and gas containing strata with CWTFT algorithms from frequency spectral structural relationships between different chords in music by analogy;

Summarizing features of frequency spectral structure modes of the same lithology in different wells, getting a frequency spectral change law of rocks, and identifying lithology of unknown rocks;
Analyzing characteristics of reservoirs from identified lithology, finding and comparing frequency spectral change characteristics of oil and gas containing reservoirs in different wells, and predicting oil and gas containing reservoirs.

Further, acquiring logging curves, and transforming the logging curves to a time domain and a frequency domain by a Fourier transform method, a Wavelet transform method and a CWTFT method.

Further still, interpolation processing of logging signal data is done by inserting linear interpolants via linear interpolation.

Still further, de-noising of the logging data in the analysis method of lithological and oil and gas containing properties of reservoirs is done by one dimensional discrete Wavelet de-noising.

Further, sound articulation analysis of the logging signal data, densely sampling and extending the logging data, increasing sound length by increasing number of data in the logging data, and increasing sound resolution; and extending existing logging data as desired with MATLAB wavelet toolbox.

Further still, conducting time-frequency characteristic analysis of logging signal data, extracting information from a frequency domain of reservoirs in the logging signals by a time-frequency analysis method of one dimensional continuous wavelet transform.

Still further, logging data by sonic log (AC) and Gamma Ray log (GR) are used as the logging signal data, and as energies provided to the logging data by different ingredients in the strata are different, after Wavelet transform, a time domain chromatograph showing energy distribution features can be ready.

Another purpose of the present invention is to provide a computer device, comprising a storage device and a processor, wherein a computer program is stored in the storage device, and the computer program when executed by the processor will perform following steps:

Acquiring a logging curve, and projecting the logging curve on a time domain and a frequency domain for analysis by Fourier transform, Wavelet transform and the CWTFT method;
Getting necessary information by frequency spectral analysis;
Summarizing frequency spectral structure features of the same lithology in different wells, getting a general rock frequency spectral change law, and identifying lithology of unknown rocks;
Analyzing features of reservoirs from identified lithology, and comparing frequency spectral change features of oil and gas containing reservoirs in different wells.

A third purpose of the present invention is to provide a computer readable storage medium, wherein a computer program is stored, and the computer program when executed by a processor will perform following steps:

Acquiring a logging curve, and projecting the logging curve on a time domain and a frequency domain for analysis by Fourier transform, Wavelet transform and the CWTFT method;
Getting necessary information by frequency spectral analysis;
Summarizing frequency spectral structural features of the same lithology in different wells, getting a general rock frequency spectral change law, and identifying lithology of unknown rocks;
Analyzing features of reservoirs from identified lithology, and comparing frequency spectral change features of oil and gas containing reservoirs in different wells.

A fourth purpose of the present invention is to provide an information data processing terminal, and the information data processing terminal is used to realize the analysis method of lithological and oil and gas containing properties of reservoirs.

A fifth purpose of the present invention is to provide an analysis system for performing the analysis method of lithological and oil and gas containing properties of reservoirs and the analysis system of lithological and oil and gas containing properties of reservoirs, which comprises:

A logging curve analysis module, for acquiring a logging curve, and projecting the logging curve on a time domain and a frequency domain for analysis by Fourier transform, Wavelet transform and a CWTFT method;
A frequency spectral analysis module for getting necessary information by frequency spectral analysis;
An unknown rock lithology identification module, for summarizing frequency spectral structural features of the same lithology in different wells, getting a general rock frequency spectral change law, and identifying lithology of unknown rocks; and
A frequency spectral change feature comparison module, for further analyzing features of reservoirs from identified lithology, and comparing frequency spectral change features of oil and gas containing reservoirs in different wells.

Taken in consideration all the foregoing technical solutions, advantageous and positive effects of the present invention are: for the first time, the present invention provides an effective tool and way for lithology and reservoir characteristics study in the time-frequency domains by one dimensional wavelet transform and continuous wavelet transform using FFT algorithm (CWTFT).

Based on logging data, taking Foundation geology, sedimentary geology, frequency spectral analysis in physics, and computer theory as a guide, the present invention interprets lithology features by frequency spectral feature analysis of the logging data, conducts sound articulation analysis of the logging lithological curves, analyzes frequency spectral characteristics of the logging data of reservoirs and identifies oil and gas containing strata.

The present invention summarizes frequency spectral response characteristics of clastic rocks and carbonate rocks by combining computer technology and frequency spectral analysis technology in physics, conducting frequency spectral analysis to the logging data, taking use of currently available well log lithology and rock cores data, comparing and analyzing lithology frequency spectral features of known wells and upon a large amount of experiments, and effectively identifies the clastic rocks and carbonate rocks with the present method.

The present invention analyzed frequency spectral response characteristics of logging curves of good reservoirs of Upper Paleozoic, predicted hydrocarbon reservoirs thereby and provides support for oil and gas exploration. Frequency spectral characteristics of logging data in Upper Paleozoic in the Dongpu Sag are interpreted scientifically and reasonably viewed against frequency spectral response characteristics oflogging curves of different lithology, which greatly improves accuracy and efficiency of lithology and reservoir interpretation. Based on this, oilfield production can be facilitated and new theoretical support and practical experience can be provided to research and exploration of deep oil and gas reservoirs.

Processing multi-dimension and non-linear logging data by frequency spectral analysis in combination with computer programming technology is conducive to improve efficiency and accuracy of geological interpretation work. Meanwhile, it is of far-reaching significance for automation and intelligent development of oil and geological industry.

Logging data are dictated by lithology, thickness and fluid properties of strata, and represent granularity, permeability and mud content etc. of sediments. By re-treatment of the logging curves, the present invention retrieves complex geological information that is not apparent in the logging curves only by frequency spectral characteristic analysis of the logging curves, and identifies different lithology and reservoir characteristics with frequency spectral features of the lithology curves. On the other hand, frequency spectral analysis of the logging data can be used to identify Milankovitch cycles, analyze sedimentary environment evolution thereby, and is used in sequence stratigraphy studies, for example, constructing signals with function cycles the same as Milankovitch cycles 1:2:5:20, namely, the function of the signals is y=sin (x)+sin (4*x)+sin (10*x)+sin(20*x), and comprises four cycles namely 2π, π/2, π/5 and π/10 (corresponding respectively to 0.16 Hz, 0.66 Hz, 1.66 Hz and 3.3 Hz), making frequency spectral analysis of actual logging data, observing which frequency contents there are and ratios between frequency contents, comparing ideal signals with frequency analysis results of actual logging data and summarizing.

### BRIEF DESCRIPTION OF THE DRAWINGS

To show technical solutions of the present invention more clearly, in the following paragraphs a brief introduction will be given to drawings used in embodiments of the present invention; apparently, the described drawings are only some embodiments of the present invention and for those of ordinary skill in the art, it is possible to get other drawings based on these drawings without involving creative work.

FIG. 1 is a flowchart diagram of an analysis method of lithology and oil and gas containing properties of reservoirs according to an embodiment of the present invention.

FIG. 2 is a structural diagram of an analysis system of lithology and oil and gas containing properties of reservoirs according to an embodiment of the present invention.

In FIG. 2, 1: logging curve analyzing module; 2: frequency spectral analyzing module; 3: unknown rock lithology identification module; 4. Frequency spectral change characteristic comparison module.

FIG. 3 is a diagram showing five-level decomposition of Acoustic log (AC) of Well Wengu 2 in the Dongpu Sag according to an embodiment of the present invention.

FIG. 4 is a diagram showing five-level decomposition of Gamma Ray log (GR) of Well Wengu 3 in the Dongpu Sag according to an embodiment of the present invention.

FIG. 5 is a diagram showing an original curve of GR of Well Qinggu 3 according to an embodiment of the present invention.

FIG. 6 is a diagram showing a curve which has been extended for 10 times according to an embodiment of the present invention.

FIG. 7 is a diagram showing relationship between porosity and depth in four wells provided in an embodiment of the present invention.

FIG. 8 is a diagram showing relationship between permeability and depth in four wells provided in an embodiment of the present invention.

FIG. 9 is a diagram showing relationship between porosity and permeability in four wells provided in an embodiment of the present invention.

FIG. 10 is a flowchart diagram showing how to use the analysis method of lithology and oil and gas containing properties of reservoirs according to one embodiment of the present invention.

### EMBODIMENTS

To show purposes, technical solutions and advantages of the present invention more clearly, hereinafter a detailed description will be given to embodiments of the present invention. It shall be understood that embodiments described here are only used to explain technical solutions of the present invention without limiting implementation of the present invention.

To address problems existing in the prior art, an embodiment of the present invention provides an analysis method, a system, a storage medium and a computer device of lithology and oil and gas containing properties of reservoirs and hereinafter a detailed description will be given to embodiments of the present invention together with the appended drawings.

As shown in FIG. 1, an analysis method of lithology and oil and gas containing properties of reservoirs, comprising following steps:

S101: acquiring a logging curve, and projecting the logging curve on a time domain and a frequency domain by Fourier transform, Wavelet transform and CWTFT.

The present invention gets frequency spectral structural modes of logging signals of different lithological bands and different oil and gas containing wells by CWTFT by analogy with frequency spectral structural relationships between different chords in music creatively.

It is necessary to state correspondence relationships between tones and corresponding frequencies. Syllables 1 (DO), 2 (RE), 3 (MI), 4 (FA), 5 (SOL), 6 (LA), and 7 (SI) correspond to musical alphabets C, D, E, F, G, A, and B, and absolute pitch is expressed by grouping. According to the popular Twelve-Tone Equal Temperament, the just interval of an octave is divided equally into twelve semitones, namely C, #C, D, #D, E, F, #F, G, #G, A, #A and B (# means a sharp), with a frequency ratio between adjacent semitones 2^{1/12}≈1.06. For example, the first A to the left of middle C (C in the immediate center of a piano) is tuned to 440 Hz, and frequency of each successive pitch can be derived, such as frequency of middle C is 523 Hz, D to the right of middle C is 578 Hz, and E is 578 Hz. A chord is a set of pitches when multiple notes sound simultaneously, for example Major Chord 135 consists of frequencies 523 Hz, 659 Hz and 784 Hz. In the present invention, response modes of frequency spectral structures of different chords in music are identified and concluded, and favorable modes are selected by identifying frequency structural modes of sandstones, carbonate rocks, and oil and gas containing strata in logging data by analogy, to know lithology and oil and gas containing features of unknown well sections.

S102: acquiring desired information by frequency spectral analysis.

S103: summarizing frequency spectral structural features of the same lithology in different wells, getting a general rock frequency spectral change law, and identifying lithology of unknown rocks;

S104: analyzing features of reservoirs from identified lithology, and comparing frequency spectral change features of oil and gas containing reservoirs in different wells.

As is shown in FIG. 10, a flowchart showing how to use the analysis method of lithology and oil and gas containing properties of reservoirs according to an embodiment of the present invention.

The analysis method of lithology and oil and gas containing properties of reservoirs according an embodiment of the present invention can be implemented in other steps, and the analysis method of lithology and oil and gas containing properties of reservoirs shown in FIG. 1 is only one of embodiments.

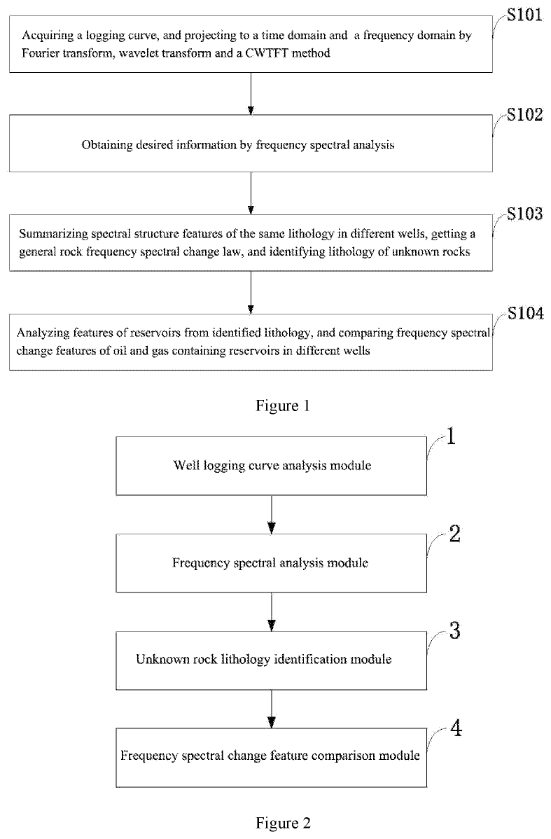

As is shown in FIG. 2, an analysis system of lithology and oil and gas containing properties of reservoirs according to an embodiment of the present invention comprises:

A logging curve analysis module 1, for acquiring the logging curves, and transforming the logging curves to a time domain and a frequency domain by Fourier transform, Wavelet transform and CWTFT;
A frequency spectral analysis module 2, for acquiring desired information by frequency spectral analysis;
An unknown rock lithology identification module 3, for summarizing frequency structural properties of the same lithology in different wells, getting a general rock frequency spectral change law and identifying lithology of unknown rocks; and
A frequency change feature comparison module 4, for analyzing features of reservoirs from identified lithology, and comparing frequency spectral change features of oil and gas containing reservoirs in different wells.

In the following paragraphs a further description will be given to technical solutions of embodiments of the present invention by way of the appended drawings.

As per a method provided in the present invention, based on inhomogeneity of distribution of reservoirs of Upper Paleozoic in Dongpu Sag and non-linearity of logging response properties, frequency spectral response characteristics of logging data in the research area are analyzed by CWTFT and continuous Wavelet transform, nature of sandstones and carbonate rocks in the research area are identified and possible oil and gas positions are predicted to improve efficiency of oil exploration and development.

### 1. Lithological Characteristic Explanation Based on Frequency Spectral Properties of the Logging Data

Underlying strata of Upper Paleozoic in Dongpu Sag comprises two parts, namely a Carboniferous period and a Permian period, which are divided into six groups, that is, Upper Carboniferous Benxi Formation, Lower Permian Taiyuan Formation, Middle Permian Shanxi Formation, Lower Permian Shihezi Formation, Upper Permian Shihezi Formation, and Upper Permian Shiqianfeng Formation. In terms of lithology, clastic rocks occur frequently, and some carbonate rocks, among which the rock types of clastic rock reservoirs mainly include fine sandstone, siltstone, argillaceous siltstone, medium sandstone, sandstone, coarse sandstone, glutenite, conglomerate, and conglomerate sandstone, among which siltstone, fine sandstone, medium sandstone, sandstone, argillaceous siltstone and conglomerate sandstone reservoirs are the most commonly seen, while carbonate rock reservoirs comprise in most cases dolomite, limestone, and dolomitic limestone. Consequently, logging data of several wells of Upper Paleozoic in Dongpu Sag are chosen to study frequency spectral characteristics of logging data of sandstones and carbonate rocks in well sections of six formations of the Upper Paleozoic in Dongpu Sag by combining with core locations and logging data and taking use of the CWTFT time-frequency analysis method.

### 1.1 Preprocessing of Logging Data:

Logging data recording changes of strata and rocks are complex and liable to changes as rocks and geological conditions are complex and liable to changes. When the logging data are used to analyze frequency spectral features of lithology, there are usually two parts of the logging data, namely a high frequency part and a low frequency part, and the low frequency data represent characteristics of logging itself, while a lot of noise components are contained in the high frequency data, along with a lot of useful information. Therefore, at the time of choosing the well sections, it is necessary to preprocess the logging data effectively, to reduce influence to the frequency spectral analysis due to noise. Main preprocessing methods include: detection and removal of aberrant points in the original logging data; identifying and reducing noise with a reasonable method; and reducing redundancy of data and scales resulted from intrinsic attributes of the logging data. Therefore, data preprocessing is a prerequisite and top priority for promising scientificity, accuracy and feasibility of experiments, and three preprocessing methods are used in embodiments of the present invention, that is, interpolation, normalization and denoising of the logging data. In the following part a detailed description will be given to the foregoing three methods.

### 1.1.1 Interpolation of the Logging Data:

Purpose of interpolation of the logging data is to digitalize the logging data of old wells, and from experiments on frequency of notes and manmade signals, it can be known that the more data are used in frequency spectral analysis, the better authenticity and stability of the original signals can be shown when identifying components and size of signals by CWTFT. A primary approach is to save the logging data as text “.txt”, introduce into Matlab, and make use of an interpolation function “interp1” in Matlab to call formatting: yi=interp1(x, y, xi, ‘method’) (wherein x and y are interpolating points, yi is an interpolating result in the interpolated point xi, x and y are vectors and ‘method’ stands for the interpolation method used). And interpolate the original logging data with codes and scripts. In the present embodiment of the present invention, linear interpolants are calculated by linear interpolation, which is a common and popular way that connects two data points near an interpolant with a straight line, and chooses data of the corresponding interpolants in the straight line. Normalization of the logging data is to reduce redundancy of data and scales resulted from intrinsic attributes of the logging data, that is, changing different scales or norms that are different substantially in size to a notionally common scale. First remove aberrant points in the logging data and normalize the same, and to facilitate selection of a stable dataset of logging curves and reflect recorded stratum information more completely, normalization of the logging data is done by a mean square root normalization algorithm and min-max feature scaling, and the commonly used method is min-max feature scaling, with scales of normalized data consistent and varying in a range of 0-1, and relativity between data remains unchanged. The maximum value is 1 and the minimum value 0. Normalization is done as per the following formula:

$${Z}_{ij} = \frac{{X}_{ij} - {X}_{ij min}}{{X}_{ij min} - {X}_{ij max}}$$

Wherein i=1, 2, . . . , n; j=1, 2, . . . , p.

### 1.1.2 Denoising of the Logging Data:

Principles of one dimensional discrete wavelet denoising are to get approximations and details of the logging signals after one dimensional discrete wavelet transform, wherein the approximations are high-scale, low-frequency components of the signals and the details are low-scale, high-frequency components, discrete wavelet decomposition is done respectively in different levels. Decomposing original signals (S) into low frequency components (a₁) and high frequency components (d₁) is level 1 decomposition, decomposing a₁ into low frequency a₂ and high frequency d₂ is level 2 decomposition and likewise until decomposing to a predetermined level.

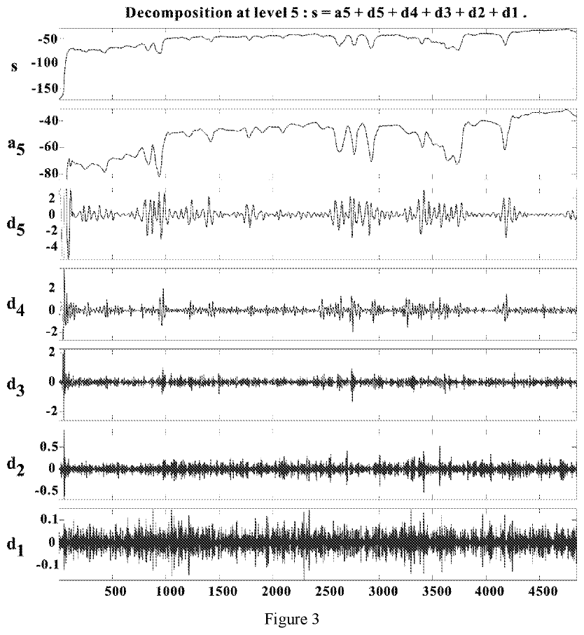

Hereinafter a multilevel decomposition is given to SP of Well Wengu 2 in Dongpu Sag by one dimensional discrete wavelet analysis, and a₅ is got after five-level decomposition of the original sample curve data and frequencies of d₁ to d₅ gradually reduce (FIG. 3).

### 1.1.3 Sample Data Collection:

In this analog test, logging curves of sixteen wells (shown in table 1 and table 2) in Dongpu Sag are used, relating to six formations namely Benxi Formation, Taiyuan Formation, Lower Shihezi Formation, Upper Shihezi Formation and Shiqianfeng Formation. Logging curves of conventional logging methods AC, SP, and GR show respectively physical characteristics of rocks such as acoustic velocity (porosity), spontaneous potentials (lithology and permeability), and radioactivity (clay content), and GR data are chosen as an analog sample for frequency spectral analysis. In the meantime, as geological structural conditions of Upper Paleozoic in Dongpu Sag is quite complex, lithology of different strata differs a lot, difference occurs in logging response characteristics of even the same lithology in different wells, rock formations of neighboring wells with good continuity shall be chosen as sample data and sampling shall be uniformly done. Table 1 shows GR curves of ten clastic rock samples taken from eight wells namely Well Wengu 3, Well Qinggu 2, Well Qinggu 1, Well Mao 5, Well Mao 6, Well Mao 8, Well Magu 2 and Well Ma 16 by stratified sampling. Table 2 shows GR curves of seventeen carbonate rock samples taken from eight wells namely Well Wengu 1, Well Langu 1, Well Ma 50, Well Magu 5, Well Magu 10, Well Donggu 2, and Well Fangu 1 by stratified sampling.

TABLE 1
GR curves of the clastic rock samples

| Well no. | Lithology | Formation | Depth of curves (m) |
|---|---|---|---|
| Well | Argillaceous | Shiqianfeng | 3716.50-3719.875 |
| Wengu 3 | siltstone | Formation | |
| | Siltstone | Shiqianfeng | 3790-3795.375 |
| | | Formation | |
| | Fine | Upper Shihezi | 4030-4035.875 |
| | sandstone | Formation | |
| Well | Argillaceous | Lower Shihezi | 3980-3988.875 |
| Qinggu 2 | siltstone | Formation | |
| Well | Argillaceous | Lower Shihezi | 4103.5-4115.375 |
| Qinggu 1 | siltstone | Formation | |
| Well Mao 5 | Argillaceous | Taiyuan | 2123.5-2128.375 |
| | siltstone | Formation | |
| Well Mao 6 | Sandstone | Shanxi Formation | 2125-2148.875 |
| Well Mao 8 | Sandstone | Shanxi Formation | 2318-2327.875 |
| Well Magu 2 | Sandstone | Taiyuan Formation | 3377-3380.875 |
| Well Ma 16 | Sandstone | Benxi Formation | 3745-3748.875 |

TABLE 2
GR curves of the carbonate rock samples

| Well no. | Lithology | Formation | Depth of curves (m) |
|---|---|---|---|
| Well | Limestone | Shiqianfeng | 3840-3841.875 |
| Wengu 2 | | Formation | |
| | Limestone | Shiqianfeng | 3842.5-3843.375 |
| | | Formation | |
| Well | Limestone | Upper Shihezi | 4007.5-4008.375 |
| Langu 1 | | Formation | |
| | Dolomite | Upper Shihezi | 4010-4010.875 |
| | | Formation | |
| | Dolomite | Upper Shihezi | 2488.5-2492.375 |
| | | Formation | |
| | Dolomite | Upper Shihezi | 2508-2511.875 |
| | | Formation | |
| | Dolomite | Upper Shihezi | 2537.5-2539.875 |
| | | Formation | |
| Well Ma 50 | Dolomite | Shanxi Formation | 3452-3454.875 |
| Well Magu 5 | Dolomite | Shanxi Formation | 3289-3291.375 |
| | Dolomite | Shanxi Formation | 2945-2946.375 |
| Well | Dolomite | Shanxi Formation | 3045-3046.375 |
| Magu 11 | | | |
| Well | Dolomite | Taiyuan Formation | 2508.375-2512.25 |
| Donggu 2 | Limestone | Taiyuan Formation | 2525-2528.875 |
| | Limestone | Taiyuan Formation | 2604-2607.875 |
| | Dolomite | Benxi Formation | 2630.5-2634.375 |
| Well | Dolomite | Taiyuan Formation | 3046.5-3050.375 |
| Magu 11 | | | |
| Well | Limestone | Taiyuan Formation | 3068.5-3072.375 |
| Fangu 1 | | | |

### 1.2 Frequency Spectral Response Features of the Logging Data:

Sandstones in Dongpu Sag and surrounding areas are similar, exhibiting characteristics such as high composition maturity, low feldspar content, and great changes in content of rock debris and interstitial fillers; in an embodiment of the present invention, GR data of sixteen wells in Dongpu Sag are chosen to analyze frequency spectral features of the clastic rocks and carbonate rocks in Dongpu Sag by CWTFT.

### 1.2.1 Frequency Spectral Response of Clastic Rock Logging Data

Lithological categories of reservoirs of Upper Paleozoic in Dongpu Sag include primarily sandstones, argillaceous siltstones, siltstones, medium sandstones, fine sandstones, and conglomerate sandstones. Extract GR logging data of sandstones in the strata of Benxi Formation, Taiyuan Formation, Lower Shihezi Formation, Upper Shihezi Formation and Shiqianfeng Formation of Upper Paleozoic in Dongpu Sag, preprocess and get corresponding frequency spectrograms by Matlab.

By analyzing ten different spectrograms of the sandstones, it can be inferred that, when the frequency value is 0.2 Hz, 0.3 Hz, 0.5 Hz, 0.7 Hz, and 1.0 Hz, frequency spectrums of Benxi Formation, Taiyuan Formation, Shanxi Formation, Lower Shihezi Formation, Upper Shihezi Formation and Shiqianfeng Formation respond apparently and with high intensity. This demonstrates that, spectral structure mode of the sandstone GR logging signals is a combination of 0.2 Hz, 0.3 Hz, 0.5 Hz, 0.7 Hz and 1.0 Hz, which is shown robustly throughout several wells and strata.

1.2.2 Currently, lithological identification study of carbonate rock reservoirs by scholars in China and abroad focuses on conventional well log and image log, and most researches are done on AC and dual laterolog. However, physical response features of carbonate rocks are very complicated due to complex reservoir space types and different interstitial fillers, and as a result, reservoir evaluation is very difficult. Lithology of carbonate rock reservoirs of Upper Paleozoic in Dongpu Sag differs a lot in rock structure, mineral composition, diagenesis and logging response, many types of reservoir space are present and of high inhomogeneity, consequently, storage and percolation mechanism and features of the reservoirs are complex, which brings trouble to reservoir identification and evaluation based on logging data. Main rock categories of carbonate rock reservoirs of Upper Paleozoic in the research area of Dongpu Sag are dolomite, lime stone and dolomite lime stone. Two types of ores are included, namely calcite and dolomite. By analyzing seventeen different spectrograms of carbonate rocks, it can be inferred that when frequency value is 0.3 Hz, 0.6 Hz, 1.0 Hz, frequency spectra of carbonate rocks (dolomite, lime stone) of Benxi Formation, Taiyuan Formation, Shanxi Formation, Lower Shihezi Formation, Upper Shihezi Formation and Shiqianfeng Formation respond apparently and with high intensity. It demonstrates that, a spectral structure mode of GR logging data of carbonate rocks is a combination of 0.3 Hz, 0.6 Hz and 1.0 Hz, which is shown robustly in several wells and strata.

### 1.3 Application Practices of an Embodiment of the Present Invention

By frequency spectral analysis technology CWTFT and the logging data, spectral response characteristics of lithology can be extracted effectively, and frequency values that appear intensively and frequently in the spectrograms can be summarized to identify lithology qualitatively in an embodiment of the present invention. In the present embodiment of the present invention, a logging curve of sandstone strata at 4055.875˜4061.5 m in Well Wengu 3 in Dongpu Sag (Upper Shihezi Formation), a logging curve of sandstone strata at 4408.5˜4411.375 m of Well Qinggu 1 (Benxi Formation), a logging curve of dolomite at 3415˜ 3415.875 m of Well Kai 3 (Upper Shihezi Formation) and a logging curve of dolomite at 2938.5˜ 2939.375 m of Well Magu 2 (Shanxi Formation) are chosen to find similar frequencies and identify lithology qualitatively based on the time-frequency analysis method CWTFT.
(1) GR of a sandstone section (4055.875˜ 4061.5 m) of Well Wengu 3 in Upper Shihezi Formation
(2) GR of a sandstone section (4408.5˜ 4411.37 m) of Well Qinggu 1 in Benxi Formation
(3) GR of a dolomite section (3415˜ 3415.875 m) of Well Kai 3 in Upper Shihezi Formation
(4) GR of a dolomite section (2938.5˜ 2939.375 m) of Well Magu 6 in Shanxi Formation

By combining chromatographs of the four well sections and analyzing, it is found that there are similar frequencies, and frequencies of sandstone sections are primarily 0.3 Hz, 0.7 Hz, and 1.0 Hz and frequencies of dolomite sections are 1.0 Hz. That establishes that, the present method has good identification effect.

### 1.4 Sound Articulation Analysis of the Logging Data

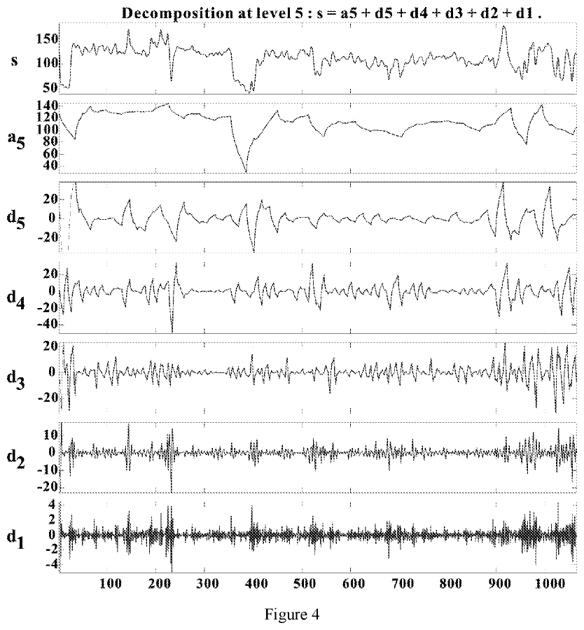

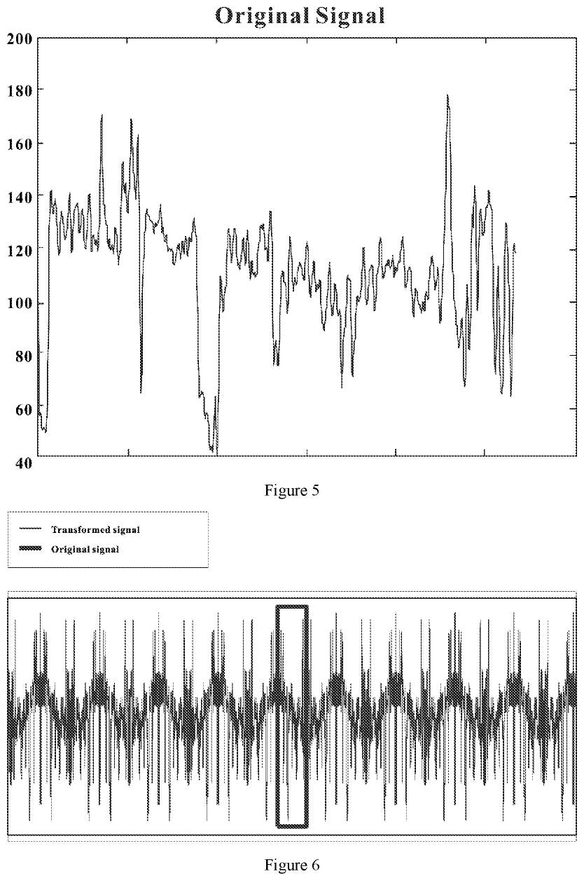

From principles of musical instruments and acoustics, it can be known from spectrograms of a note A (440 Hz) pronounced by a piano and a note in the same range of sound pronounced by a guitar, that their fundamental frequencies are approximately consistent, however, harmonics and amplitude thereof differ greatly. Different sounds are heard exactly because frequency components of the musical notes are different. The fundamental reason can be traced in material difference between musical instruments, that is, piano and guitar. Based on this law, lithology curves of different lithology (porosity and density etc.) are extracted, processed in Matlab, and exported as “sound” files to see whether audio difference can be perceived, and use sound difference to infer lithology characteristics indirectly. Choose logging data that are continuous and cover a variety of lithology, combine lithology logging data, process with “sound” function in Matlab, and have the logging data articulate corresponding “sound”. There are primarily two kinds of logging curve sound articulation analysis; the first one is to divide the original logging curve into multiple sub-curves with frequencies ranging from high to low with Matlab, and analyze separately according to frequencies. The second one is to analyze as a whole; while studying data regarding sound files from the natural world, it is found that a numerous amount of data are contained in the sound files from the natural world, however, there is relatively much less logging data and as a result, sound articulated by the logging data is very short or there is no sound at all. Therefore, prior to process the data with “sound” function, there is an important step to observe, that is, to densely sample and extend the logging data, increase length of sound articulated by the logging data by increasing number of data in the logging data and increase sound resolution thereby. Existing logging data can be extended to a desired target by “Signal Extension” under “Extension” column in Matlab wavelet toolbox. Finally a better identification effect can be achieved by combining sound articulation features of both the first and the second kinds of analysis. Herein, a GR curve of Well Qinggu 3 (4122˜ 4245 m) with data length 1063 is chosen to analyze with the first analysis method, namely in the following steps: choosing “sym” wavelet mother-function, decomposing into five levels (as shown in FIG. 4) namely d₁, d₂, d₃, d₄, and d₅, which are sub-curves separated from the original curve with frequencies ranging from high to low, naming the five sub-curves entirely as “myyou”, saving to workspace of Matlab, and hearing sound features with the “sound” function. Specific statement is: d₁=myyou (1,:); d₂=myyou (2,:); d₃=myyou (3,:); d₄=myyou (4,:); d₅=myyou(5,:); sound (d₁); sound (d₂); sound (d₃); sound (d₄); sound (d₅). First of all, five sounds, which is in essence a kind of sound that is divided into five according to frequencies, are heard. An immediate feeling is that, sound of d₁ is very sharp and high, and sound becomes gradually low and deep when it comes to d₅. Again the GR curve of Well Qinggu 3 (4122˜ 4245 m) with original data length 1063 is chosen to be extended for ten times with the second analysis method, until data length becomes 10630, and further extension can be done if necessary.

Name the new curve after extension as “qinggu3GR”, save to workspace of Matlab, and hear sound articulation features with the “sound” function. Specific statement is: sound (qinggu3GR) and sound features of the extended curve can be heard. It is found that, articulated sound is disconnected and very short, which sounds like the sound occurs when a radio is lagging. By comparison, it is observed that, sound duration when analyzing with the second method is very short, and even after extension of the original curve, sound pronounced is repeating that of the original curve and is prone to influence of the original curve. While sound articulated by the first method is quite long and makes it easy to perceive sound resolution, therefore, in embodiments of the present invention, musical instrument and acoustic principles are used to examine lithology features of rocks.

### 2. Frequency Spectral Response Characteristics of Logging Data of Physical Parameters of Reservoirs

In petroleum geology and engineering, porosity and permeability are two important physical parameters, and spatial inhomogeneity of their distribution influences distribution, fluid flow and excavation of oil reservoirs directly. Therefore, in an embodiment of the present invention, logging data of reservoirs developed in Shiqianfeng Formation, Upper Shihezi Formation, and Lower Shihezi Formation of good porosity and permeability are chosen for spectral feature analysis.

### 2.1 Physical Parameters of Reservoirs:

Most of reservoirs in Dongpu Sag are sandstone reservoirs, with most of the storage space induced porosity, which comprises intergranular pores, intragranular pores, and intercrystalline pores etc.; size of the pores decides storage capacity of a reservoir directly and permeability controls production capacity of a reservoir. Good hydrocarbon indication is present in Well Qinggu 3 drilled in a later phase in Dongpu Sag, and categories of storage space in Well Qinggu 3, are chiefly residual primary intergranular pores and secondarily induced intergranular dissolved pores in Shiqianfeng Formation. And in Lower Shihezi Formation, most of them are interstitial micro-pores and secondarily induced dissolved pore and induced intercrystalline pores.

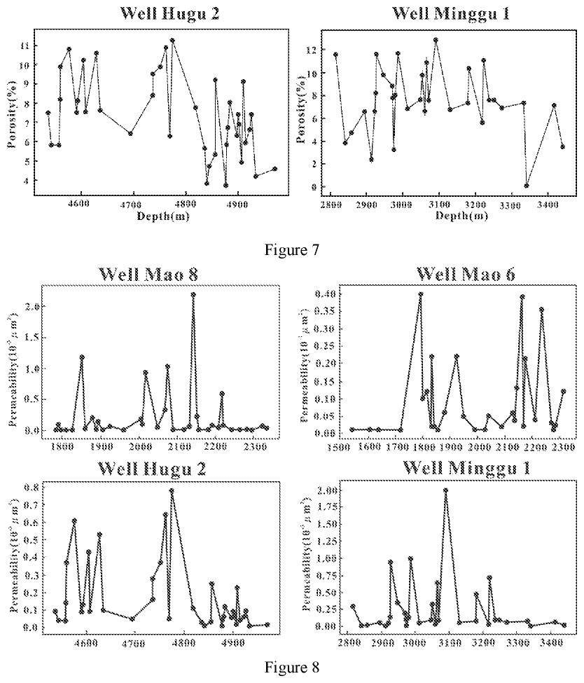

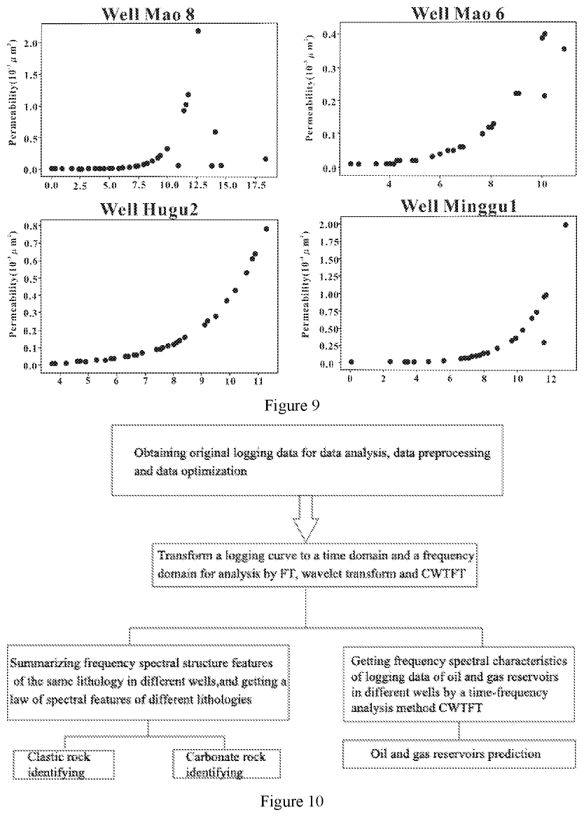

In an embodiment of the present invention, totally 152 datasets for physical parameter logging interpretation of sandstone reservoirs of some well sections are chosen for statistical analysis, such as Upper Shihezi Formation, Shanxi Formation and Taiyuan Formation sections of Well Mao 6 1542˜ 2314.5 m; Shiqianfeng Formation, Upper Shihezi Formation, Lower Shihezi Formation and Shanxi Formation sections of Well Mao 8 1782.7˜ 2333.35 m; Upper Shihezi Formation, Lower Shihezi Formation sections of Well Minggu 1 2817.2˜ 3439.7 m and Upper Shihezi Formation, Shiqianfeng Formation and Lower Shihezi Formation sections of Well Hugu 2 4536.4˜ 4971.1 m, to try to analyze relationship between physical parameters of sandstone of Upper Paleozoic in Dongpu Sag and strata. After accounting and statics, it is found that, porosity of sandstone strata in Well Mao 6 deep 1600-2300 m is mainly 4%-10%, and average porosity 6.5%; porosity of sandstone strata in Well Mao 8 deep 1800˜ 2300 m is distributed mainly in a range of 2%-13% with average porosity 7%; porosity of Well Minggu 1 deep 2800˜ 3400 m is mainly 2%˜ 12%, with average porosity 7%; and porosity of sandstone strata in Well Hugu 2 deep 4600˜ 4900 m is distributed over 4.5%˜ 11%, with average porosity 7.5%. taken in consideration of the foregoing statistics, it is observed that values of porosity of sandstone strata of Upper Paleozoic in Dongpu Sag are basically distributed in a range of 2% ˜12% with average porosity 7.5%, however there is no apparent relationship shown between value of porosity and change of depth (as can be seen in FIG. 7). Permeability of sandstone strata in Well Mao 6 deep 1600˜ 2300 m is mainly 0.02-0.2×10⁻³ μm², with highest permeability 0.4×10⁻³ μm²; permeability of sandstone strata of Well Mao 8 deep 1800˜ 2300 is distributed chiefly in 0.02-0.2×10⁻³ μm², with few points in a interval of 1-2×10⁻³ μm²; permeability of sandstone strata of Well Minggu 1 deep 2800˜ 3400 m is mainly in an interval of 0.02-0.55×10⁻³ μm², with the highest permeability 2×10⁻³ μm²; and permeability of sandstone strata of Well Hugu 2 deep 4600˜ 4900 m is mainly 0.02-0.4×10⁻³ μm² with highest permeability about 0.8×10⁻³ μm² (as can be seen in FIG. 8). In view of the foregoing data, it is found that, values of permeability of sandstone strata of Upper Paleozoic in Dongpu Sag are distributed in an interval of 0.02-0.5×10⁻³ μm², and mostly in an interval of 0.02-0.04×10⁻³ μm², and there is no apparent relationship between value of permeability and change of depth. A relationship between porosity and permeability of sandstone reservoirs of Upper Paleozoic in Dongpu Sag is shown in FIG. 9, wherein it can be seen as the permeability grows the porosity increases. Except few discrete points, in general there is an obvious exponential correlation between porosity and permeability of sandstone. Upon a comprehensive analysis of FIG. 7, FIG. 8 and FIG. 9, it is observed that sandstone reservoirs of Upper Paleozoic in Dongpu Sag exhibits a low-porosity and low-permeability characteristic. Furthermore, permeability of sandstone reservoirs of Upper Paleozoic in Dongpu Sag is limited by porosity, and when porosity is low, interconnectivity of pores is low, pore throats are small, making it difficult for oil and gas to move between strata; and when porosity is high, interconnectivity among pores is increased and permeability is increased too.

### 2.2 Time-Frequency Feature Analysis of Logging Data of Reservoirs:

Propaganda of acoustic waves in rocks is subject to influences from many factors, and will undergo geometrical attenuation and resistive padding. Consequently, propaganda of acoustic signals in rocks is unstable, which establishes necessity and applicability of time-frequency analysis. In the embodiments of the present invention, necessary information is extracted from the frequency domain of logging signals of reservoirs based on conventional logging data and by a CWTFT analysis method. Morlet wavelet function used in the embodiments of the present invention is a periodic function smoothed by a Gaussian function, and each of stretching or shrinking scales a of Morlet wavelet function corresponds to each of cycles T in Fourier transform.

### 2.2.1 Selection of the Logging Data

Logging data are consisted of different components, and contain a large amount of reservoir information, which is a sum of information such as micro-pore structure, clay content and fluid properties of the strata. Among many logging data of sedimentary rock formations, GR curve can reflect more sensitively change of clay content and is correlated closely to clay porosity and micro-pores and in the meantime, GR log is the easiest while an important method of radioactive log. AC log is usually used to study porosity of rocks, and can be used together with GR log for interpretation. Study on evolution rules of forming environment can be assisted by AC logging data, which is a good choice and proven effective. Therefore, in the embodiments of the present invention, AC logging data and GR logging data are chosen and as energies provided by compositions in the strata to the logging data are different, it is possible to get time-frequency chromatograms of different energy distribution features after wavelet transform, which makes it possible to analyze signals.

### 2.2.2 Time-Frequency Analysis of GR Logging Data of Well Wengu 1

(1) Time-Frequency Analysis of GR Logging Data in Well Wengu 1

When it is to analyze time-frequency features of logging data of reservoirs, choose formations of good porosity and permeability. For example, three well sections namely Well Wengu 1 Upper Shihezi Formation 4116.2˜ 4122.3 m, 4189˜ 4023 m and 4222˜4306.6 m, and all of these three well sections have good hydrocarbon indications. After normalization and denoising the GR logging data of Well Wengu 1 with Matlab, carry out a one-dimensional continuous wavelet transform, perform a wavelet transform with the longest scale 256, the smallest scale 1, and a step size 1 and get a time-frequency chromatogram after wavelet transformation. By analyzing the time-frequency chromatograms of the abovementioned three well sections, it is found that multiple scale overlaying phenomena happen in the wave spectrum, value of the scales are primarily 90, 105, and 158 corresponding to frequencies 0.011 Hz, 0.009 Hz and 0.006 Hz. Conduct another wavelet transform to the GR curve with the longest scale 128, the smallest scale 1 and a step size 1, and get a time-frequency chromatograms after wavelet transformation. By analyzing chromatograms of the abovementioned three well sections, it is found that multiple scale overlaying phenomena happen again in the wave spectrum, with values of the multiple scales are primarily 27, 56, 66 and 79. In light of the above, it is found that, scales of multiple scale overlaying in the wave spectra are 27, 56, 66, 79, 90, 105 and 158, corresponding to frequencies 0.037 Hz, 0.017 Hz, 0.015 Hz, 0.012 Hz, 0.011 Hz, 0.009 Hz, and 0.006 Hz.

(2) Time-Frequency Analysis of AC Logging Data of Well Wengu 1

When it is to analyze time-frequency features of logging data of reservoirs, choose formations of good porosity and permeability. For example, three well sections namely Well Wengu 1 Upper Shihezi Formation 4116.2˜ 4122.3 m, 4189˜ 4023 m and 4222˜4306.6 m, and all of these three well sections have good hydrocarbon indications. After normalization and denoising the AC logging data of Well Wengu 1 with Matlab, carry out a one-dimensional continuous wavelet transform, perform a wavelet transform with the longest scale 256, the smallest scale 1, and a step size 1 and get a time-frequency chromatogram after wavelet transformation. By analyzing the time-frequency chromatograms of the abovementioned three well sections, it is found that multiple scale overlaying phenomena happen in the wave spectrum, value of the scales are primarily 27, 40 and 63 corresponding to frequencies 0.037 Hz, 0.025 Hz and 0.016 Hz. Conduct another wavelet transform to the AC curve with the longest scale 128, the smallest scale 1 and a step size 1, and get a time-frequency chromatograms after wavelet transformation.

By analyzing chromatograms of the abovementioned three well sections, it is found that multiple scale overlaying phenomena happen again in the wave spectrum, with values of the multiple scales are primarily 88, 131 and 235. In light of the above, it is found that, scales of multiple scale overlaying in the wave spectra are 27, 40, 63, 88, 131 and 235, corresponding to frequencies 0.037 Hz, 0.025 Hz, 0.015 Hz, 0.016 Hz, 0.011 Hz, and 0.004 Hz.

(3) Time-Frequency Analysis of GR Logging Data in Well Wengu 2

When it is to analyze time-frequency features of logging data of reservoirs, choose formations of good porosity and permeability. For example, four well sections namely Well Wengu 2 Upper Shihezi Formation 3913˜ 3834 m, 3891˜ 3893 m, 4037˜4047 m and 4056˜ 4060 m, and all of these four well sections have good hydrocarbon indications. After normalization and denoising the GR logging data of Well Wengu 2 with Matlab, carry out a one-dimensional continuous wavelet transform, perform a wavelet transform with the longest scale 256, the smallest scale 1, and a step size 1 and get a time-frequency chromatogram after wavelet transformation. By analyzing the time-frequency chromatograms of the abovementioned three well sections, it is found that multiple scale overlaying phenomena happen in the wave spectrum, value of the scales are primarily 94, 144, 158 and 230 corresponding to frequencies 0.011 Hz, 0.007 Hz, 0.006 Hz and 0.004 Hz. Conduct another wavelet transform to the GR curve with the longest scale 128, the smallest scale 1 and a step size 1, and get a time-frequency chromatograms after wavelet transformation.

By analyzing chromatograms of the abovementioned four well sections, it is found that multiple scale overlaying phenomena happen again in the wave spectrum, with values of the multiple scales are primarily 30, 40, 51, 60, 94, 144, 158 and 230. In light of the above, it is found that, scales of multiple scale overlaying in the wave spectra are 30, 40, 51, 60, 94, 144, 158 and 230, corresponding to frequencies 0.033 Hz, 0.025 Hz, 0.019 Hz, 0.017 Hz, 0.011 Hz, 0.007 Hz, 0.006 Hz and 0.004 Hz.

(4) Time-frequency analysis of AC logging data in Well Wengu 2

When it is to analyze time-frequency features of logging data of reservoirs, choose formations of good porosity and permeability. For example, four well sections namely Well Wengu 2 Upper Shihezi Formation 3913˜ 3834 m, 3891˜ 3893 m, 4037˜4047 m and 4056˜ 4060 m, and all of these four well sections have good hydrocarbon indications. After normalization and denoising the AC logging data of Well Wengu 2 with Matlab, carry out a one-dimensional continuous wavelet transform, perform a wavelet transform with the longest scale 256, the smallest scale 1, and a step size 1 and get a time-frequency chromatogram after wavelet transformation. By analyzing the time-frequency chromatograms of the abovementioned three well sections, it is found that multiple scale overlaying phenomena happen in the wave spectrum, value of the scales are primarily 118, 131 and 170 corresponding to frequencies 0.008 Hz, 0.007 Hz, and 0.006 Hz. Conduct another wavelet transform with the longest scale 128, the smallest scale 1 and a step size 1 to the AC curve, and get a time-frequency chromatograms after wavelet transformation. By analyzing chromatograms of the abovementioned four well sections, it is found that multiple scale overlaying phenomena happen again in the wave spectrum, with values of the multiple scales are primarily 40, 40, 53 and 92. In light of the above, it is found that, scales of multiple scale overlaying in the wave spectra are 40, 53, 92, 118, 131 and 170, corresponding to frequencies 0.025 Hz, 0.019 Hz, 0.011 Hz, 0.008 Hz, 0.007 Hz, and 0.006 Hz.

(5) Time-Frequency Analysis of GR Logging Data in Well Hugu 2

When it is to analyze time-frequency features of logging data of reservoirs, choose formations of good porosity and permeability. For example, four well sections namely Well Hugu 2 Shiqianfeng Formation 4572˜ 4605 m, 4748˜ 4767 m, 4854˜4854 m and 4908˜ 4914 m, and all of these four well sections have good hydrocarbon indications. After normalization and denoising the GR logging data of Well Hugu 2 with Matlab, carry out a one-dimensional continuous wavelet transform, perform a wavelet transform with the longest scale 256, the smallest scale 1, and a step size 1 and get a time-frequency chromatogram after wavelet transformation. By analyzing the time-frequency chromatograms of the abovementioned three well sections, it is found that multiple scale overlaying phenomena happen in the wave spectrum, value of the scales are primarily 94, 118 and 158 corresponding to frequencies 0.011 Hz, 0.008 Hz, and 0.006 Hz. Conduct another wavelet transform to the GR curve with the longest scale 128, the smallest scale 1 and a step size 1, and get a time-frequency chromatograms after wavelet transformation. By analyzing chromatograms of the abovementioned four well sections, it is found that multiple scale overlaying phenomena happen again in the wave spectrum, with values of the multiple scales are primarily 40, 51, and 85. In light of the above, it is found that, scales of multiple scale overlaying in the wave spectra are 40, 51, 85, 94, 118 and 158, corresponding to frequencies 0.025 Hz, 0.019 Hz, 0.012 Hz, 0.011 Hz, 0.008 Hz, and 0.006 Hz.

(6) Time-Frequency Analysis of AC Logging Data in Well Hugu 2

When it is to analyze time-frequency features of logging data of reservoirs, choose formations of good porosity and permeability. For example, four well sections namely Well Hugu 2 Shiqianfeng Formation 4572˜ 4605 m, 4748˜ 4767 m, 4854˜4854 m and 4908˜ 4914 m, and all of these four well sections have good hydrocarbon indications. After normalization and denoising the AC logging data of Well Hugu 2 with Matlab, carry out a one-dimensional continuous wavelet transform, perform a wavelet transform with the longest scale 256, the smallest scale 1, and a step size 1 and get a time-frequency chromatogram after wavelet transformation. By analyzing the time-frequency chromatograms of the abovementioned three well sections, it is found that multiple scale overlaying phenomena happen in the wave spectrum, value of the scales are primarily 90, 134 and 144 corresponding to frequencies 0.011 Hz, 0.007 Hz, and 0.007 Hz. Conduct another wavelet transform to the AC curve with the longest scale 128, the smallest scale 1 and a step size 1, and get a time-frequency chromatograms after wavelet transformation. By analyzing chromatograms of the abovementioned four well sections, it is found that multiple scale overlaying phenomena happen again in the wave spectrum, with values of the multiple scales are primarily 30, 42 and 70. In light of the above, it is found that, scales of multiple scale overlaying in the wave spectra are 30, 42, 70, 90, 134 and 144, corresponding to frequencies 0.033 Hz, 0.024 Hz, 0.014 Hz, 0.011 Hz, 0.007 Hz, and 0.007 Hz.

From time-frequency analysis of GR, and AC logging data of reservoirs in the abovementioned three wells, it can be known that spectra of multiple scales superimposing occurs in the time-frequency chromatograms of GR logging data of Shiqianfeng Formation and Shihezi Formation of Upper Paleozoic in Dongpu Sag after wavelet transform, superimposing scales are mainly 51 (0.019 Hz), 94 (0.011 Hz) and 158 (0.006 Hz). And by observing logging curves of well sections with hydrocarbon production or indication, it can be known that, GR values are usually medium or low, and shape of the curves includes toothed boxes. In the meantime, AC values are usually low, spectra of multiple scales superimposing is observed in the time-frequency chromatograms too, with the scale values primarily 40 (0.025 Hz), 90 (0.011 Hz) and 131 (0.007 Hz).

### 2.3 Application Instances of Identification of Suspicious Oil and Gas Reservoirs

Hereinafter, a further description will be given to embodiments of the present invention by instance outcomes.

By the CWTFT time-frequency analysis technology and the logging data, in embodiments of the present invention, features of signals in the frequency domain of reservoirs are effectively extracted, and values of scales of superimposing spectra are known to predict suspicious oil and gas reservoirs. In an embodiment of the present invention, GR and AC logging curves of a well section 5020˜ 5340 m in Shiqianfeng Formation and Upper Shihezi Formation of Well Pushen 8 in Dongpu Sag, combining the time-frequency analysis method with one-dimensional continuous Morlet wavelet, to identify values of scales of superimposing spectra and well sections with good GR curve fitting and locate suspicious oil and gas reservoirs to provide basis for actual well drilling.

In an instance according to an embodiment of the present invention, wavelet transform is conducted on a GR logging curve of Well Pushen 8 with Matlab, with the following transform parameters: the smallest scale 1, the longest scale 256, step size 1, and a wavelet transform based time-frequency chromatography is got; setting the transform parameters as following: the smallest scale 1, the longest scale 128, step size 1, and another wavelet transform based time-frequency chromatography is got. Time-frequency chromatograms when the longest scales are different can be known from wavelet spectral characteristic charts of GR of reservoirs of Well Pushen 8.

In the embodiments of the present invention, superimposing of multiple scales occurred, taken in conjunction with values of scales of a high curve fitting ratio and analyzing the chromatograms and it is shown that: a. when the value of the scale in the wavelet spectral characteristic chart of GR of reservoirs in Well Pushen 8 is 46 (0.022 Hz), well sections 5106˜ 5118 m, 5161˜ 5212 m, 5226˜ 5232 m and 5240˜5334 m are covered; b. when the value of the scale is 92 (0.011 Hz), well sections 5164˜5198 m, 5240˜ 5272 m, 5280˜ 5288 m and 5327˜ 5334 m are covered; c. when the value of the scale is 157 (0.006 Hz), well sections covered are 5212˜ 5162 m, 5240˜5254 m, 5280˜ 5286 m, 5296˜ 5306 m and 5328˜ 5334 m.

In another instance according an embodiment of the present invention, a wavelet transform is done on an AC logging curve of Well Pushen 8 with Matlab, with the following transform parameters: the smallest scale 1, the longest scale 256, step size 1, and a wavelet transform based time-frequency chromatogram is got. Set the parameters to be: the smallest parameter 1, the longest parameter 128, step size 1, another wavelet transform based time-frequency chromatogram is got. Time-frequency chromatograms when the longest scales are different can be known from wavelet spectral characteristic charts of AC of reservoirs of Well Pushen 8.

In the embodiments of the present invention, superimposing of multiple scales occurred, taken in conjunction values of scales of a high curve fitting ratio and analyzing the chromatograms, it is shown that: a. when the scale in the spectral characteristic chart of AC wavelet of reservoirs in Well Pushen 8 is 40 (0.025 Hz), well sections covered are 5086˜ 5125 m, 5146˜ 5154 m, 5176˜ 5192 m and 5218˜ 5330 m; b. when the scale is 92 (0.011 Hz), well sections covered are 5086˜ 5098 m, 5108˜5114 m, 5180˜ 5190 m, 5220˜ 5272 m and 5284˜ 5290 m; c. when the scale is 131 (0.007 Hz), well sections covered are 5086˜ 5098 m, 5180˜ 5190 m and 5218˜ 5275 m.

Combining characteristics of the time-frequency chromatograms of the aforementioned hydrocarbon development area, it is inferred that, two well sections 5180˜ 5190 m and 5240˜ 5254 m in Well Pushen 8 are suspicious oil and gas locations, which has been proven true by other prospection documents.

By the above instances, embodiments of the present invention proposed a new time-frequency analysis method, that is a combination of one dimensional continuous wavelet transform and fast Fourier transform, CWTFT, tested reliability of the method with a large number of ideal signal experiments and prepared solutions for any irregular circumstances based on conventional time-frequency analysis methods such as wavelet transform and Fourier transform by comparing their advantages and disadvantages and taken advantage of computer technology; finally taken lithology and physical parameters of reservoirs of Upper Paleozoic in Dongpu Sag as objects, and based on logging data of relevant well sections, the present invention conducted analysis and study on frequency spectral characteristics of lithology and frequency spectral response characteristics of reservoirs and reached the following conclusions:

Principles of CWTFT is introduced by combining wavelet transform and Fourier transform, and a lot of manmade signals (phase shift), sound signals of piano and guitar are used to for analogy, and realization method of CWTFT is elaborated with frequency spectral structure of the abovementioned signals. Aberrance of frequency spectral structures got by this method has been discussed, and the following concepts are concluded: a. during signal construction, when a sampling frequency is greater than or equal to two times of the largest frequency in the signals, a frequency spectrogram can be made, however, when the sampling frequency is two times of the largest frequency in the signals, there is no aberrance (or just minor) at both ends and the effect is better. b. spectral aberrance at both ends is subject to influences of the following two factors, namely “frequency” and “number of data”, specifically, when the sampling frequency is two times of the maximum frequency of the signals, the more data contained (there is no conclusion with regard to how many), the better is effect of the frequency spectrogram, without aberrance at both ends. c. to obtain a better identification effect, a ratio between the number of data points and the largest frequency of identified signals shall be promised to be greater than or equal to 3300/500=6.6. d. phase shift in the signals has no influence to frequency spectral analysis outcomes. e. resonance happens with frequency components lower than minor third, that is, when frequency multiplying is lower than 1.1892 (2\hat{ }(3/12)) to 1.0293 (2\hat{ }(0.5/12) half frequency) and when frequency multiplying is greater than 1.2599 (2\hat{ }(4/12)) no resonance happens. It is necessary to differentiate resonance and co-frequency, and the smaller frequency multiplying is, the co-frequency is more liable to happen.

Using the time-frequency analysis method CWTFT, and with the frequency spectral features of clastic rock and carbonate rocks concluded according to the method provided by an embodiment of the present invention, frequency spectral structure feature of a first sandstone section and a second sandstone section of Shiqianfeng Formation in Well Wengu 3, a first sandstone section of Upper Shihezi Formation and a second sandstone section of Benxi Formation of Well Wengu 3, a second sandstone section of Upper Shihezi Formation in Well Qinggu 1, a first sandstone section of Lower Shihezi Formation in Well Qinggu 2, a first sandstone section of Taiyuan Formation in Well Mao 5, a second sandstone section of Shanxi Formation in Well Mao 6, a first sandstone section of Shanxi Formation in Well Mao 8, a second sandstone section of Taiyuan Formation in Well Magu 2, and a first sandstone section of Benxi Formation in Well Ma 16 are analyzed individually, and concluded that, when the frequencies are 0.2 Hz, 0.3 Hz, 0.5 Hz, 0.7 Hz, and 1.0 Hz, frequency spectra of clastic rocks of all six formations have responded obviously; and in the same manner, when frequencies are 0.3 Hz, 0.6 Hz and 1.0 Hz, frequency spectra of carbonate rocks of all six formation have responded evidently; and clastic rocks in Well Wengu 3 and Well Qinggu 1 and carbonate rocks in Well Kai 3 and Well Magu 6 have been successfully identified.

The method provided by an embodiment of the present invention has been applied to analyze sound articulation characteristics of the logging data by Matlab with two methods, namely “frequency-wise” and “extension”. Take a GR logging curve of Well Qinggu 3 (4112˜ 4245 m), two methods are used in turn, and by the “frequency-wise” method, five sounds of the same nature divided from a kind of sound in an decreasing order of values of frequencies are got. The most obvious feeling is that, sound made by d1 is very sharp and high, and sound becomes gradually low and deep when it comes to d5. By the “extension” method, it is found that sound pronounced is discontinuous and very short, something like sound produced when a radio is frozen. By comparison of the two methods, it is found that sound articulation duration with the “extension” method is very short and extension of the original curve is just a repeat thereof.

The foregoing description is directed to embodiments of the present invention, however, protection scope of the present invention is not limited by the same, all modifications, equivalent replacements and improvements within spirits and principles of embodiments of the present invention made those skilled in the art shall fall in protection scope of the present invention.

1. An analysis method of lithology and oil and gas containing properties of reservoirs, characterized in that, the analysis method of lithology and oil and gas containing properties of reservoirs comprising:
Getting frequency spectral structure modes of logging signals of different lithological bands and different oil and gas containing strata with CWTFT algorithms from frequency spectral structural relationships between different chords in music by analogy;
Summarizing features of frequency spectral structure modes of the same lithology in different wells, and getting a frequency spectral change law of rocks, and identifying lithology of unknown rocks;
Analyzing characteristics of reservoirs from identified lithology, finding and comparing frequency spectral change characteristics of the oil and gas containing strata in different wells, and predicting oil and gas containing reservoirs.

2. The analysis method of lithology and oil and gas containing properties of reservoirs according to claim 1, wherein the analysis method comprises further:
acquiring logging curves, and transforming the logging curves to a time domain and a frequency domain by a Fourier transform method, a Wavelet transform method and the CWTFT algorithms.

3. The analysis method of lithology and oil and gas containing properties of reservoirs according to claim 1, wherein the analysis method comprises further:
interpolation processing of logging signal data is done by inserting linear interpolants via linear interpolation.

4. The analysis method of lithology and oil and gas containing properties of reservoirs according to claim 1, wherein the analysis method comprises further:
de-noising of the logging data in the analysis method of lithological and oil and gas containing properties of reservoirs is done by one dimensional discrete Wavelet de-noising.

5. The analysis method of lithology and oil and gas containing properties of reservoirs according to claim 1, wherein the analysis method comprises further:
sound articulation analysis of the logging signal data by densely sampling and extending the logging data, increasing sound length by increasing number of data in the logging data, and increasing sound resolution; extending existing logging data as desired with MATLAB wavelet toolbox.

6. The analysis method of lithology and oil and gas containing properties of reservoirs according to claim 2, wherein the analysis method comprises further:
An analysis method in the time domain and the frequency domain is a time-frequency analysis method with one dimensional continuous wavelet transform.

7. The analysis method of lithology and oil and gas containing properties of reservoirs according to claim 1, wherein logging data by sonic log (AC) and Gamma Ray log (GR) are used as well log signal data in the analysis method in the time domain and the frequency domain, and a time domain chromatograph showing energy distribution features is acquired by wavelet transform.

8. A computer readable medium, where a computer program is stored, and the computer program when executed by a processor will carry out following steps:
Acquiring a logging curve, and projecting the logging curve on a time domain and a frequency domain for analysis by Fourier transform, wavelet transform and CWTFT algorithms;
Getting necessary information by frequency spectral analysis;
Summarizing frequency spectral structure features of the same lithology in different well, concluding a general rock frequency spectrum change law, and identifying lithology of unknown rocks; and
Analyzing features of a reservoir by identified lithology, and finding and comparing frequency spectral change features of oil and gas containing reservoirs in different wells.

9. An analysis system for executing the analysis method of lithology and oil and gas containing reservoirs according to claim 1, wherein the analysis system of lithology and oil and gas containing reservoirs comprising:
A logging curve analysis module, for acquiring a logging curve, and projecting the logging curve on a time domain and a frequency domain for analysis by Fourier transform, Wavelet transform and a CWTFT method;
A frequency spectral analysis module for getting necessary information by frequency spectral analysis;
An unknown rock lithology identification module, for summarizing frequency spectral structure features of the same lithology in different wells, getting a general rock frequency spectral change law, and identifying lithology of unknown rocks; and
A frequency spectral change feature comparison module, for further analyzing features of reservoirs from identified lithology, and finding and comparing frequency spectral change features of oil and gas containing reservoirs in different wells.
